(19) United States
(12) Patent Application Publication
(10) Pub. No.: US 2024/0185636 A1
(43) Pub. Date: Jun. 6, 2024

(54) IMPAIRMENT ANALYSIS SYSTEMS AND RELATED METHODS

(71) Applicant: IAlyze, LLC, Chapel Hill, NC (US)

(72) Inventors: Willem Prins, Chapel Hill, NC (US); Alexander Adam Papp, Raleigh, NC (US); Matthew E. Czajkowski, Chapel Hill, NC (US)

(21) Appl. No.: 18/442,020

(22) Filed: Feb. 14, 2024

Related U.S. Application Data
(63) Continuation-in-part of application No. 17/132,319, filed on Dec. 23, 2020, now Pat. No. 11,908,129.
(60) Provisional application No. 62/954,094, filed on Dec. 27, 2019.

(51) Int. Cl. G06V 40/20; B60Q 9/00; G06T 7/00; G06T 7/246; G06V 10/141; G06V 10/56; G06V 10/70; G06V 20/59; G06V 40/18; G06V 40/19; G06V 40/60

(52) U.S. Cl. CPC G06V 40/20; B60Q 9/00; G06T 7/0014; G06T 7/246; G06V 10/141; G06V 10/56; G06V 10/70; G06V 20/597; G06V 40/19; G06V 40/193; G06V 40/197; G06V 40/67; G06T 2207/20081; G06T 2207/30201; G06T 2207/30268

(57) ABSTRACT

Impairment analysis systems and related methods are disclosed. According to an aspect, a vehicular impairment detection system for a vehicle includes an interface configured to communicate a start control signal to a start system of a vehicle. A computing device is configured to control the light source to emit light in a predetermined pattern for guiding the subject's eyes. Further, the computing device is configured to receive captured images. The computing device maintains a database of machine learning analysis of other subject's normal and abnormal eye behavior in response to an applied light stimulus. Further, the computing device is configured to classify pixels based on the database of machine learning analysis. The computing device is configured to track movement of the classified pixels in the plurality of images over the period of time. The computing device communicates a control signal to disable the start system of the vehicle.

### CROSS REFERENCE TO RELATED APPLICATIONS

This is a continuation-in-part patent application that claims priority to U.S. Nonprovisional patent application Ser. No. 17/132,319, filed Dec. 23, 2020, and titled IMPAIRMENT ANALYSIS SYSTEMS AND RELATED METHODS, which claims priority to U.S. Provisional Patent Application No. 62/954,094, filed Dec. 27, 2019, and titled IMPAIRMENT ANALYSIS SYSTEMS AND RELATED METHODS; the contents of which are incorporated herein by reference in their entireties.

### TECHNICAL FIELD

The presently disclosed subject matter relates generally to impairment analysis systems and related methods.

### BACKGROUND

Systems have been developed for determining whether a subject is impaired. For example, such systems can determine whether the subject is impaired due to alcohol or drug use, sleep deprivation, or a medical condition. Some systems can determine alcohol or drug induced impairment by tracking and analyzing eye movement of the subject. Particularly, for example, it has been demonstrated scientifically that there is a correlation between a blood alcohol concentration (BAC) greater than a certain value (e.g., a BAC greater than 0.08) and the presentation of horizontal gaze nystagmus (HGN) in a subject. Also, vertical gaze nystagmus (VGN) can be an effective indicator of alcohol impairment.

In the case of automobile or other vehicle use, technologies have been developed to test for the presence and levels of alcohol and/or drugs. Upon detection of impairment, these technologies can prevent the person from operating the vehicle. Further, such technologies may be required under a proposed new standard for vehicles to be equipped for detecting and preventing impaired driving.

There is a desire to provide improved systems and techniques for determining whether a subject is impaired and preventing operation of a vehicle upon detection of impairment.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a diagram of an impairment analysis system in accordance with embodiments of the present disclosure;

FIG. 2 is a top perspective, front view of an attachment for a computing device for implementing impairment analysis in accordance with embodiments of the present disclosure;

FIG. 3 is a top perspective, rear view of the attachment shown in FIG. 2;

FIG. 4 is a flow diagram of an example method for impairment analysis in accordance with embodiments of the present disclosure;

FIG. 5 is a flow diagram of an example method for impairment analysis in accordance with embodiments of the present disclosure;

FIG. 6 is a graph that depicts intoxication gauged based on pupillary responses;

FIG. 7 is an image of landmarks on a rendered face for creating reference points;

FIG. 8 is a diagram of a vehicular impairment detection system within a vehicle's interior in accordance with embodiments of the present disclosure;

FIG. 9 is a diagram of the vehicular impairment detection system with indications of alternative positions of light sources;

FIG. 10 is a diagram of the vehicular impairment detection system with a distance sensor, one or more ambient light sensors, and a light source in accordance with embodiments of the present subject matter;

FIG. 11 is a flow diagram of an example method for vehicular starting and testing in accordance with embodiments of the present disclosure;

FIG. 12 is a flow diagram of an example method that follows the method of FIG. 11 in accordance with embodiments of the present disclosure;

FIG. 13 is a flow diagram of an example method for vehicle start and testing procedures as a continuation of the method of FIG. 12 in accordance with embodiments of the present disclosure;

FIG. 14 is a flow diagram of an example method for vehicle start and testing procedures as a continuation of the method of FIG. 13 in accordance with embodiments of the present disclosure; and

FIG. 15 is a flow diagram of an example method for vehicle start and testing procedures as a continuation of the method of FIG. 14 in accordance with embodiments of the present disclosure.

### SUMMARY

The presently disclosed subject matter relates to impairment analysis systems and related methods. According to an aspect, a vehicular impairment detection system for a vehicle includes an interface configured to communicate a start control signal to a start system of a vehicle. The system also includes a light source configured for attachment to an interior component of the vehicle. Further, the system is an image capture device that captures a plurality of images of an eye of a subject illuminated by light over a period of time. The image capture device is configured for attachment to an interior component of the vehicle. A computing device is configured to control the light source to emit light in a predetermined pattern for guiding the subject's eyes during capture of the plurality of images of the eye over the period of time. Further, the computing device is configured to receive, from the image capture device, the captured plurality of images, wherein the images include pixels corresponding to a pupil, iris, background, or other features of the eye of the subject. The computing device is also configured to maintain a database of machine learning analysis of other subject's normal and abnormal eye behavior (e.g., movement) in response to an applied light stimulus. Further, the computing device is configured to classify pixels from the captured plurality of images as either pupil, iris, background, or other features of the eye of the subject based on the database of machine learning analysis. The computing device is also configured to track movement of the classified pixels in the plurality of images over the period of time. Further, the computing device is configured to analyze impairment of the subject based on the tracked movement as compared to the machine learning analysis in the database. The computing device is also configured to determine that the subject is at an unsafe level of impairment based on the analysis of impairment. Further, the computing device is configured to communicate, to the interface, a control signal to disable the start system of the vehicle based on a determination that the subject is at an unsafe level of impairment.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

As referred to herein, the term “eye behavior” can refer to any type of eye movement or other recognizable behavior. For example, eye behavior can include the tracked movement horizontally, vertically or another direction. In another example, eye behavior can include pupil dilation, pupillary reaction and pupillary unrest (hippus). In other examples, eye behavior can include ductions, versions, vergence, accommodation reflex, vestibulo ocular reflex, saccades, and pursuit. Examples of abnormal eye behavior as a result of impairment from alcohol include, but are not limited to, nystagmus which can be involuntary movements of the eye. Nystagmus can be vertical, horizontal, torsional, convergence-divergence or a mix of these. Other examples of abnormal eye behavior which can be related to impairment from cannabis and some other drugs include, but are not limited to, dilated pupils, slow pupillary reaction, rebound dilation, pupillary unrest (hippus), and convergence insufficiency. Another example of eye behavior is abnormal dilation of the conjunctival vessels overlying the sclera. There are numerous other forms of abnormal eye behavior in addition to those cited here, which should be understood by those of skill in the art.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, REFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device and may be embodied in any suitable form and organized within any suitable type of data structure. The operational data may be collected as a single data set or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly redundant forwarding services to move packets between distribution layer devices in different regions of the network. The core layer typically includes multiple routers and switches.

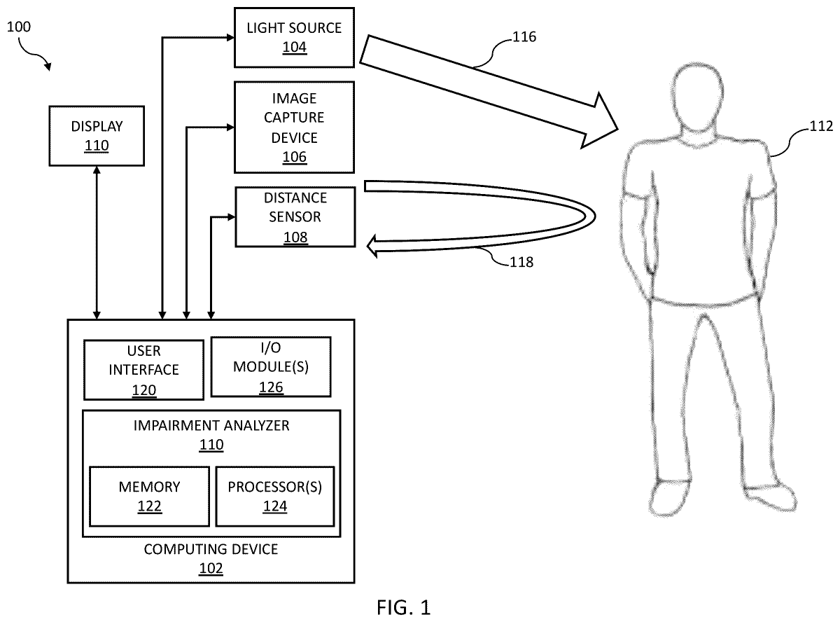

FIG. 1 illustrates a diagram of an impairment analysis system 100 in accordance with embodiments of the present disclosure. Referring to FIG. 1, the system 100 includes a computing device 102, a light source 104, an image capture device 106, a distance sensor 108, and a display 110. As an example, the light source may be a light emitter or referred to as a “light emitter”. The computing device 102 may be, for example, a smartphone, a tablet computer, or the like. Each of the light source 104, image capture device 106, distance sensor 108, and display 110 may be communicatively connected to the computing device 102 by wired or wireless connection. Further, each of the light source 104, image capture device 106, distance sensor 108, and display 110 may be mechanically connected to the computing device 102 to facilitate containment in one unit and also carry by a user or operator. In an example, one or more of the light source 104, image capture device 106, distance sensor 108, and display 110 may be integrated into the computing device 102.

In accordance with embodiments, the light source 104 may be configured to direct light towards a subject, such as subject 112, undergoing impairment analysis. The light may be displayed in a predetermined pattern that serves as a stimulus for the subject 112 undergoing impairment analysis and who is directed to follow with his or her eyes. The distance sensor 108 may be configured to determine the location of the subject 112. The image capture device 106 may be a video camera or still camera configured to capture one or more images (including video) of the subject 112. The light source 104, image capture device 106, and distance sensor 108 may each be operatively controlled by the computing device 102 for implementing the functions disclosed herein.

The computing device 102 may include an impairment analyzer 114 for implementing functionality described herein. The impairment analyzer 114 may be configured to control the light source 104 to emit light in a predetermined pattern to present a light stimulus to the subject 112. Light directed to the subject 112 by the light source 104 is indicated by arrow 116.

The impairment analyzer 114 may receive from the distance sensor 108, information regarding the determined location of the subject 112. For example, the distance sensor 108 may be an ultrasonic sensor that can measure the distance to the subject 112 by emitting a sound wave (generally indicated by arrow 118) at a particular frequency and listening for the return of that sound wave 118 in order to time the trip of the sound wave 118 to the subject 112 and back for determining the distance or an approximation of the distance. The information received at the computing device 102 from the distance sensor 108 may be data or information about the distance or distance approximation.

Further, the impairment analyzer 114 may receive from the image capture device 106, the captured image(s) of the subject 112. The captured image(s) may include one of a facial movement and position of the subject while the subject 112 is following the light stimulus is applied to the subject 112 in a predetermined location with respect to the distance sensor 108. For example, the captured image(s) processed by the impairment analyzer 114 may only be the image(s) captured while the subject 112 is within the predetermined location, i.e., a location suitable for impairment analysis in accordance with embodiments of the present disclosure.

The impairment analyzer 114 may, as described in more detail herein, use the facial movement and/or position of the subject 112 for analyzing impairment of the subject 112. Further, the impairment analyzer 114 may present to a user of the system 100, a result of the impairment analysis. For example, computing device 128 may include a user interface 120 including a display for presenting the result. In another example, the display 110 may be used by the computing device to display the result.

The impairment analyzer 110 may be implemented by any suitable hardware, software, firmware, and/or the like. For example, the impairment analyzer 110 may include memory 122 and one or more processors 124 for implementing the functionality disclosed herein. The computing device 102 may include one or more input/output (I/O) modules 126 for operatively connecting the computing device 102 to one or more of the light sources 104, image capture device 106, distance sensor 108, and the display 110.

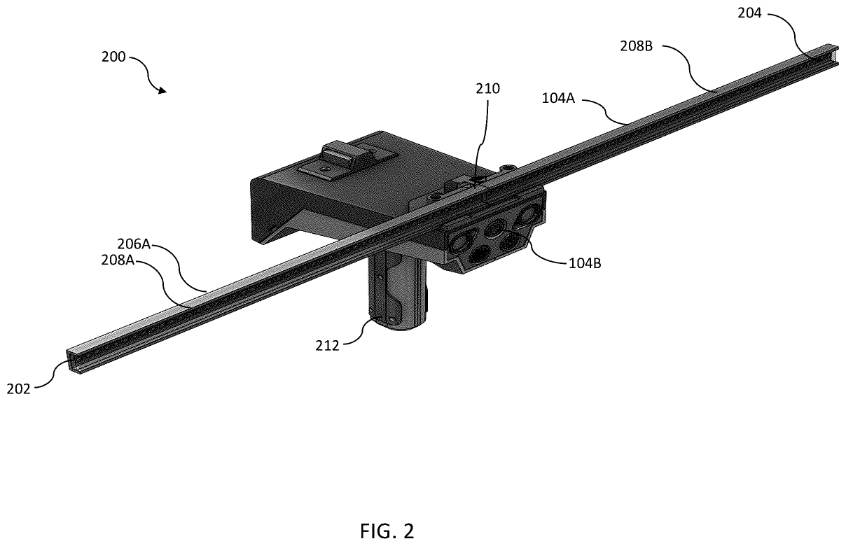

FIG. 2 illustrates a top perspective, front view of an attachment 200 for a computing device (not shown) for implementing impairment analysis in accordance with embodiments of the present disclosure. Referring to FIG. 2, the attachment 200 may include multiple light sources 104A and 104B, an image capture device 106, and a distance sensor 108 that may have the same or similar functionality to the corresponding components shown in FIG. 1. In the example of FIG. 2, light source 104A is a strip of LEDs or LED system that extends between two ends 202 and 204 of a support structure 206. The LED system includes multiple LEDs that are separate from each other and that extend substantially along a straight line along the support structure 206. In this example, the LEDs are evenly spaced apart from its neighboring LED; however, the LEDs may be arranged in any suitable manner.

The support structure 206 may include a first portion 208A and a second portion 208B that are attached to each other and movable with respect to each other. In this example, portions 208A and 208B are pivotally connected and movable with respect to each other at a pivot area 210. LEDs 206A are attached to portion 208A, and LEDs 206B are attached to portion 208B. The impairment analyzer can control the LEDs 206A and 206B to emit light in accordance with a predetermined pattern for presenting a light pattern stimulus to a subject. For example, the LED strip may perform the function of a stimulus during an HGN test (e.g., moving left and right and holding the subject's gaze). Further, the light from the LED strip can illuminate one or more of the subject's eyes.

The distance sensor 108 may be an ultrasonic distance sensor configured to detect distance to the subject in real time and verify that the subject is in the correct location while the test is administered. Using an ultrasonic sensor (in combination with a video camera), the subject may be detected without the need for any device contact, and is not affected by the object's color or optical characteristics such as reflectivity, transparency or opacity. This sensor can operate regardless of illumination conditions.

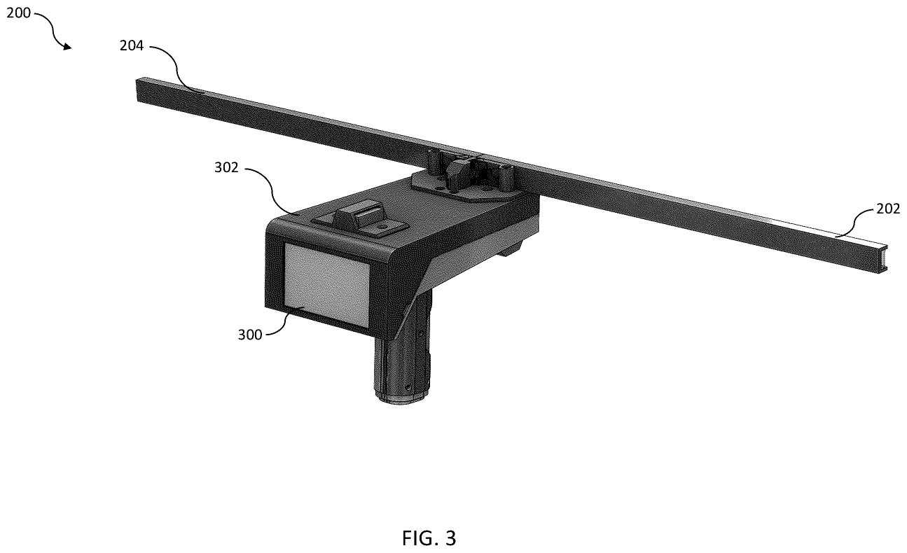

The image capture device 106 may be an infrared-type camera configured to capture and record the subject's eye movement during an HGN exam. The camera and/or computing device may keep a timestamped record for future reference of the exam. The camera is a non-contact device that detects electromagnetic energy (visible wavelengths and/or heat) and converts it into an electronic signal, which is then processed by the computing device to produce an image on a display (e.g., video monitor shown in FIG. 3). The device can record images during the day with visible light, or at night possibly with an additional light source. The high frame rate and IR can be advantageous for the application of machine learning.

The attachment 200 may include a base 212 that can mechanically attach to a computing device such that the attachment 200 is supported by the computing device or vice versa

FIG. 3 is a top perspective, rear view of the attachment 200 shown in FIG. 2. Referring to FIG. 3, the attachment 200 includes a video monitor 300 for the display of thermal images captured by the camera. In an example, the display 300 may be an LCD display that can be interacted with by the user in real time. The display 300 can display a menu and finite state machine stepping through the HGN processes for interaction by the user.

The attachment 200 may include a housing 302 that contains a micro-controller. The micro-controller may use a program to administer the examination by performing a series of LED sequences while recording eye movement. The microcontroller may operate with a button and display interface. A single board computer can process the video information, and may store in memory the recordings with a timestamp and name of the test sequence. The impairment analyzer disclosed herein may be implemented by the micro-controller and its memory. Further, the housing 302 may contain other electronics such as a rechargeable battery for powering its electronics.

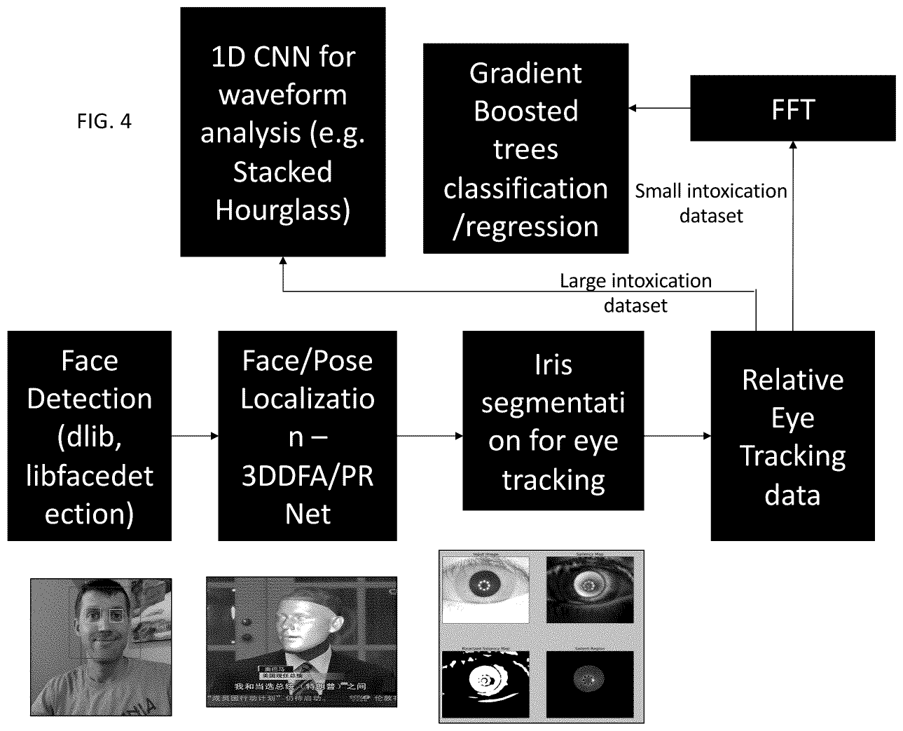

FIG. 4 illustrates a flow diagram of an example method for impairment analysis in accordance with embodiments of the present disclosure. The method may be implemented by the impairment analyzer disclosed herein. Referring to FIG. 4, the method includes a face detection step. Subsequently, the method includes face/pose localization. Key points are identified and localized on the face. These key points are used to obtain a normalized frame of reference for tracking relative iris movement. As a preprocessing step, the key points are passed through Bayesian stabilization filters for robust normalization. Further, the method includes iris instance segmentation for eye tracking. For intoxication analysis, an assessment can be provided in several ways. One such method is using a machine learning algorithm trained on previous eye movement data as a function of time. Another method is to do a spectral analysis and determine BAC with a precalculated thresholding of frequency components.

Iris instance segmentation may be implemented by computer vision made possible by deep learning algorithms. This processing method is extremely robust to various lighting conditions and can be performed on both a single or multichannel image. The iris instance segmentation may be offloaded to a separate processor that is optimized to run edge inference of deep learning models (e.g. the NVIDIA Jetson nano). It may also be uploaded to a remote server to perform faster and more robust processing.

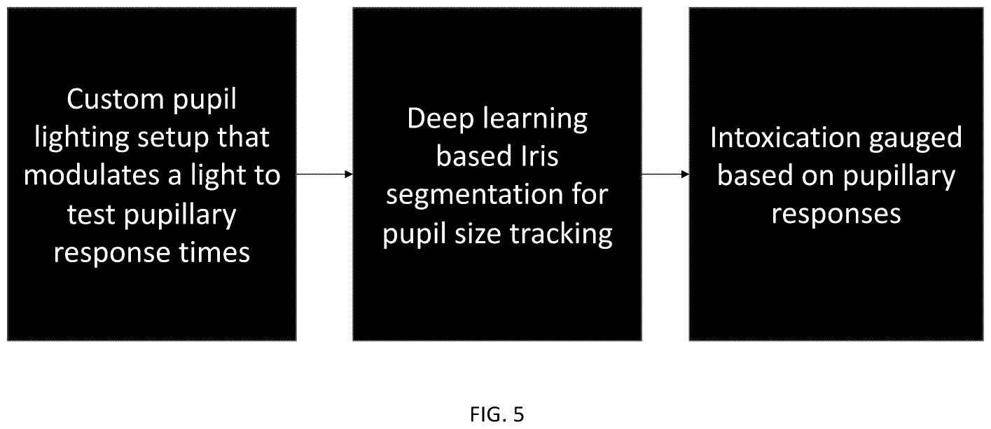

FIG. 5 illustrates a flow diagram of an example method for impairment analysis in accordance with embodiments of the present disclosure. The method may be implemented by the impairment analyzer disclosed herein. Referring to FIG. 5, the method includes a step of custom pupil lighting setup that modules or operates a light to test pupillary response times. Further, the method includes deep learning based on iris instance segmentation for pupil size tracking. The method also includes a step of gauging intoxication based on pupillary responses.

In an example of HGN detection for impairment analysis, a video of the person is captured using the camera on the prototype device. The video is captured using a camera with infrared lighting illuminating the face at 20-180 Hz and each frame is sequentially analyzed. This video feed is the beginning of the processing pipeline. The next three steps are applied to each frame with the final steps occurring using the aggregated data extracted from the frames. The processor may be an edge computing device, e.g. an ARM CPU found on the raspberry pi 3, but may also be a Jetson nano which has the same range of functionality including deep learning support. An open-source facial detection algorithm is used to detect the face in the picture. This can be from any number of libraries but OpenCV or dlib may be used. Once a face is detected, facial landmarks (e.g. corner of mouth, noise tip, jaw line, etc.) are computed, which correspond to a number of points in different positions on the subject's face. From here a facial pose/position are calculated and used as a reference point. This can be a weighted average of all the points. This reference point is necessary because there is a Gaussian noise introduced by the movement of the camera/subject from frame to frame, and because of the measurement noise of the algorithms themselves. The iris is segmented. Each eye is cropped using common ratio from a human face and the segmentation masks are created. From these segmentation masks the iris centers are calculated and stored normalized to the reference point. The segmentation can be performed a number of ways. From there a shape fitting algorithm may be used to increase the accuracy of the detected instances. To classify clues, the eye movement data is stored as time series data and signal processing techniques, including windowing and distance measuring may be applied to measure eye movement frequencies that allow us to classify the stability/smoothness of eye movement, which is the mathematical interpretation of “stuttering” eye movement seen in intoxicated subjects during the horizontal gaze nystagmus test.

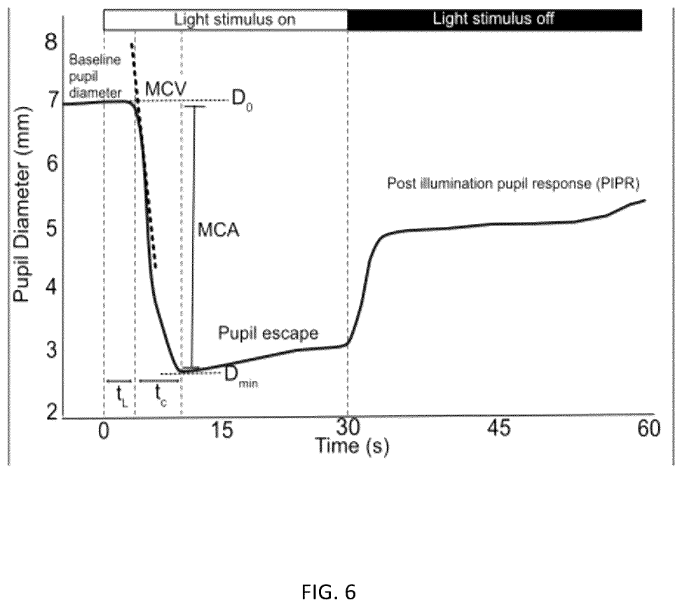

FIG. 6 is a graph that depicts intoxication gauged based on pupillary responses.

In accordance with embodiments, the system may use a modulation of a light source and tracking of iris/pupil sizes as described herein. This pipeline may be simpler from an algorithmic point. Because the entire image is being segmented on iris/pupil versus not iris/pupil, a facial reference point is not used to determine localization of the pupils. Only area is being measured in this example. The segmentation may be performed on the same video from the camera and subsequently the pupil size is plotted similar to the graph shown in FIG. 6. As the baseline is determined at the beginning of a test, several of these factors can be thresholded within the pupillary response to determine whether there is cannabis intoxication present.

In accordance with embodiments, a handheld, battery powered device is provided for impairment analysis. For example, the device may include the components of the system 100 shown in FIG. 1. The device may have multiple CPUs and a GPU which runs an operating system that records video, manages stimulus, and runs/evaluates signal processing algorithms. The device may be operable to communicatively connect to a WI-FI® network or any other communications network. The device may include a rechargeable battery. It is non-invasive, meaning it never has to make contact with a subject, such as subject 112 shown in FIG. 1.

The device may have a screen that can show distance measurements and can display what part of the nystagmus processing it is performing. The screen can guide the user in performing the test.

The device may have one or more distance sensors. The distance sensor(s) may operate by using ultrasound pulses that reflect off an object and it listens for the return and times it to detect what is directly in front of the sensor. The distance sensor can be important because the official roadside nystagmus test requires the device to be held at a distance of 12-15 inches. Multiple sensors may be used to achieve the accuracy and precision needed to properly assess whether a subject is exhibiting nystagmus. The distance sensor is used in the backend processing to normalize the pupil size so small perturbations in movement between the device and subject boost accuracy in backend processing.

The device may include a light with illumination intensity controlled by the onboard CPU. This light can emit infrared+visible light, or just infrared lighting. The light may be used so the device can function in at any time of day/night and so it can help normalize the lighting in the images for backend processing

The device may include a light sensor to assess the lighting conditions and inform the processing chain when determining nystagmus/BAC/THC blood concentration. Further, the device may have a stimulus in the form of a fold out LED strip that guides the eyes by turning on and off the LEDs in a sequential manner in a pattern controlled by the CPU. This LED strip guides the eyes to perform the 4 steps of the nystagmus test. The mechanical device is designed to operate multiple sensors for the collection of data to be fed to the signal processing backend. These multiple data sources are analyzed in parallel with machine learning techniques to increase the accuracy of the intoxication measurements.

In accordance with embodiments, techniques for impairment analysis disclosed herein can involve deep learning. Using a movie as an analogy, the algorithm can segment and track the actor in front of any background. Deep learning algorithms are much more sophisticated and are “trained”. These algorithms can learn context about the pictures, e.g. when certain groupings of pixels are together, that usually means they represent a dog, or in a different grouping, a cat. These algorithms that have contextual awareness learned from these millions of datapoints, and can be tuned to work on eye images.

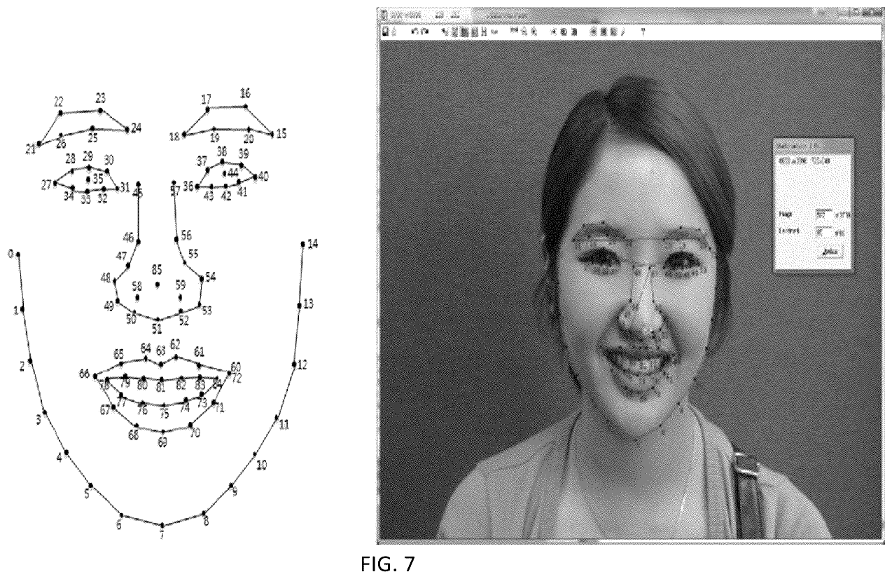

In an example case, a frame (a picture) is taken in by the camera at a framerate determined by the algorithms at variable resolution. The frame contains the subject face in Red Green Blue (“RGB”) values. Each frame is processed by the deep learning backend algorithms to find the face. A second deep learning algorithm is used to identify the same 68 landmarks that every face contains. FIG. 7 illustrates images including an image of a person's and landmarks for creating a reference points. These landmarks are used to create a reference point between all frames capture for stabilizing the face. They are also used to crop out the eyes so that high resolution processing is performed only on the area around the eyes, which allows real time processing. Each eye is shown to a third deep learning algorithm which classifies every pixel in the image as either belonging to a pupil, iris, or “background” (background here means non pupil/iris) This is called image segmentation and the algorithm is trained on many images as described in the note above and customized for eyes. When the iris pixels are segmented, the algorithm uses an ellipse estimation algorithm that tunes the edges of the deep learning algorithm to nicely fit onto the iris. The center of that ellipse is then calculated and stored. The center of the ellipse represents the pupil location and using the reference landmarks, the absolute position of the eye can be determined and tracked over time. The processing chain can run the standard four nystagmus tests that are present in a roadside test, tracks the absolute 2D coordinates of the pupils, and compares them to what the algorithm calculates should be the baseline eye movement of a non-intoxicated individual. The baseline eye movement is calculated using geometry. The movement pattern of the lit up LEDs on the device can be controlled along with the distance from the person's face. Subsequently, the process can work backwards to where their eyes should be looking and the rate of change for their iris positioning.

In a comparison, the positions of the iris over time are compared to the ideal positions of the irises over time and an algorithm which calculates the distance between the two points determines the intensity of nystagmus present in the subject under test. This level of nystagmus allows us to gauge the BAC because the larger “distances” in this comparison indicate a more drastic intoxication level. An additional feature in is determining the precise Blood Alcohol Content based on the angle of onset of nystagmus. This can be implemented by the operator pausing the light source at the moment when onset is detected. Data from the precise location of the emitter at the time angle of onset is detected and the exact distance from the subject is used to calculate the angle of onset using triangulation. The algorithm may assess all the data within the four tests and returns a “clue” for each test, indicating whether or not nystagmus is present, and finally it can return an estimation of the subjects Blood Alcohol concentration. The video of the process can be saved and labeled. In addition, data showing the location of the light stimulus on the emitter at each point in time and the angle of onset are also saved. All of this can be retrieved from the device for presentation in court or various other uses.

For cannabis/blood THC content sensing, the physical device housing may be the same. The CPU can measure the lighting in the environment to set the baseline. The device has a focused light source that illuminates the subjects face with a lumen determined by the device to achieve a measurable pupillary response. The light is controlled by the processor and is turned on and off for precise series of times. The device captures frames of the subject's face during initial calibration, the illumination of the face, and post illumination as the pupils reset to their initial size. The backend algorithm is measuring the pupil sizes using the backend processing described during the nystagmus process. The determination of blood THC concentration is calculated based off of several metrics in the expected pupillary response, normalized from the lighting and initial pupil size. The blood THC concentration estimation is then presented to the user via the screen and the videos are also saved. The same pupillary response curves can be used to correlate BAC levels as pupillary response is a bioindicator of intoxication. The metrics for THC, BAC, and several other pharmacological intoxicators can be determined from a pupillary response curve when illumination and the full response is recorded.

In accordance with embodiments, systems and methods are disclosed for determining impairment of a vehicle driver (or subject) and controlling operation or start of the vehicle based on the determination. Particularly, a system in accordance with embodiments can detect whether a driver of a vehicle is impaired by alcohol use and/or drug use. The system, in an example, can automate a series of observations of the eyes which can be used by law enforcement officers when they perform Standard Field Sobriety Tests (“SFSTs”). The system can be integrated into a vehicle's interior, such as a cabin of an automobile. For example, the system's components can be integrated in during manufacture of the vehicle. In another example the system's components can be attached and integrated into the vehicle post-manufacture in after market applications of the technologies. The system for implementation of these and other functionalities described herein can be referred to as a “vehicular impairment detection system”.

In accordance with embodiments, a vehicular impairment detection system can include one or more light sources that guide the subject's eyes. Further, the system can include a distance sensor configured to determine the location of the subject. The system can also include an image capture device (e.g., a camera) configured to capture one or more images of the subject. Further, the system can include a computing device configured to control the light source(s) to emit light in a predetermined pattern to apply light stimulus to the subject. The computing device can also be configured to receive, from the distance sensor, information regarding the determined location of the subject. Further, the computing device can be configured to receive, from the image capture device, the captured image(s) of the subject including one of a facial movement and position of the subject while the light stimulus is applied to the subject.

The vehicular impairment detection system can automatically detect a number of what are referred to in the HGN SFST procedure as “clues” and the aggregated results can then be used to determine whether a driver is impaired or not. The vehicular impairment detection system can also evaluate the degree of red in the sclera due to dilation of the conjunctival vessels (commonly known as “bloodshot eyes”). This is one of the initial observations that are used by police officers to determine whether a subject may have consumed alcohol. The system can also determine whether a subject has difficulty keeping her or his head facing forward without movement when the eyes are being directed to extreme gaze. The inability to do so is also considered a clue. In addition, the start control can detect whether a subject's eyes can pursue a stimulus smoothly from side to side. It can also detect the presence of nystagmus which is a physiological anomaly that occurs in the eyes of impaired individuals. It does so both at what is referred to as Extreme Gaze and can also determine the angle of first onset (“Angle of Onset”) of nystagmus as the subject moves their eyes toward extreme gaze. The system can also detect nystagmus in Vertical Gaze Nystagmus (“VGN”) which is when the subject's eyes are directed to the maximum upward gaze. This procedure can be used in the HGN Nystagmus Test.

In accordance with embodiments, the presently disclosed subject matter can disable the vehicle to prevent the vehicle from starting if a series of “clues” and observations confirm that a driver is impaired or likely to be impaired, including, but not limited to, “bloodshot eyes,” the inability to hold head still during an HGN test and the presence of nystagmus. The vehicular impairment detection system may direct a vehicle with a self-driving function to pull over to park the vehicle in a safe location after nystagmus is detected. If a vehicle is disabled by the vehicular impairment detection system, there can be a reset mechanism which would allow a different driver to operate the vehicle if the system determines they are not impaired. The initial driver may also use the reset function to retake the test when they believe they are not impaired or are no longer impaired.

The standard field sobriety test (“SFST”) for Nystagmus specifies several tests to determine impairment. In embodiment, these tests are enabled by the vehicular impairment detection system disclosed herein. An example test is the “smooth pursuit” test, which checks whether the subject eye is observed to have a “jerk” movement when following light. In another test, an HGN test is used to observe an involuntary jerking of the eyes, occurring as the eyes gaze toward the side. Another test is the VGN test which observes an involuntary jerking of the eyes (upward and downward movements) which occurs when the eyes gaze upward at maximum elevation. There is no known drug that causes VGN without causing at least four clues of HGN. If VGN is present and HGN is not, it could be a medical condition. For VGN to be recorded, it must be distinct and sustained for a minimum of four seconds at maximum elevation. Resting Nystagmus is referred to as a jerking of the eyes as they look straight ahead. Its presence usually indicates a medical condition or high doses of a Dissociative Anesthetic drug such as PCP.

The entire procedure as specified in the SFST is intended to take 80 seconds which includes two sweeps of the eyes from side to side to detect smooth pursuit, two sweeps to extreme gaze with a pause to detect nystagmus and two sweeps to detect the point of onset of nystagmus prior to extreme gaze.

In accordance with embodiments, the vehicular impairment detection system is configured to perform some or all of these tests in accordance with the HGN SFST guidelines. However, it can also be programmed to only perform part of the procedure in order to reduce the time to detect nystagmus. In addition, the system can detect an abnormally red sclera (known as “bloodshot”) eyes and the inability to hold the head steady while attempting to move the eyes to extreme gaze.

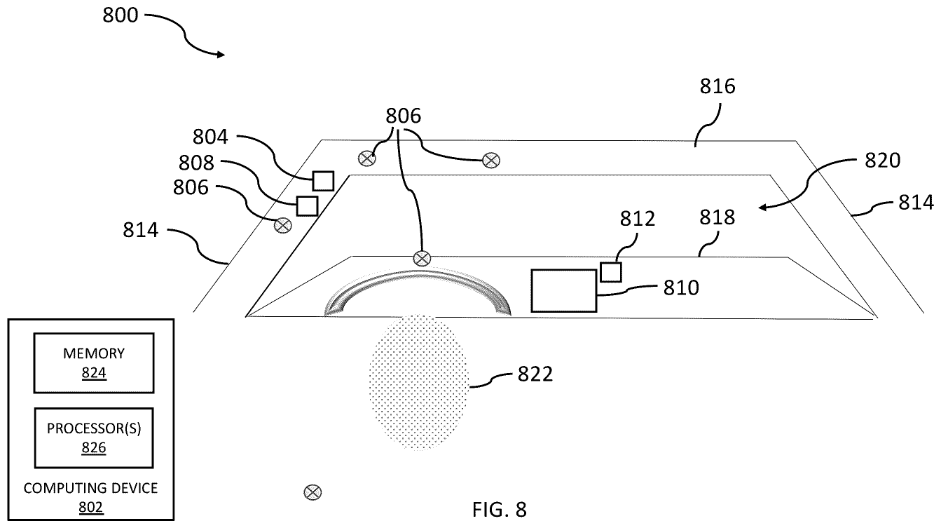

FIG. 8 illustrates a diagram of a vehicular impairment detection system 800 within a vehicle's interior in accordance with embodiments of the present disclosure. Referring to FIG. 8, the system 800 includes a computing device 802, a light source 804, one or more image capture devices 806, a distance sensor 808, a display 810, and a speaker 812. In this example, any suitable number of these components may be utilized and arranged within the vehicle's interior.

The vehicle's interior includes a pair of A-pillars 814 that carries, in part, the vehicle's roof 816. A dashboard 818 extends between the A-pillars 814. A windshield, generally designated 820, is between the A-pillars 814, the roof 816, and the dashboard 818. A driver's head is depicted by reference 822. It should be understood that the locations of these components are examples, and their sizes, orientations, and positioning with respect to each other may differ depending on the vehicle. Also, the attachment to and positioning of the light source 804, the one or more image capture devices 806, the distance sensor 808, the display 810, and the speaker 812 to these interior components of the should be considered examples and may be alternatively positioned. The representation of the computing device 802 is a block diagram in this figure, and it should be understood that it may be suitably positioned within the vehicle and operatively connected to the light source 804, the one or more image capture devices 806, the distance sensor 808, the display 810, and the speaker 812.

The display 810 and the speaker 812 for announcing voice prompts may be incorporated into existing devices which serve other functions in the vehicle. Each of the light source 804, the image capture device(s) 806, the distance sensor 808, and the display 810 may be communicatively connected to the computing device 802 by wired or wireless connection.

In accordance with embodiments, the light source 804 may be configured to direct light towards the subject's head 822 for implementing impairment analysis. The distance sensor 808 may be configured to determine the distance of the subject's face from the distance sensor 808 itself and through geometry the distance of the subject's face from the light source 804. The image capture device(s) 806 may be a video camera or configured to capture one or more images (including video) of the subject. The light source 804, the image capture device(s) 806, and the distance sensor 808 may each be operatively controlled by the computing device 802 for implementing the functions disclosed herein. For vehicular use the presently disclosed subject matter may use one or more high definition cameras permanently attached in the vehicle and located in positions where the cameras have an unobstructed view of the driver's face. The cameras can be located in the area just above the windshield on the driver's side on either side of their face or possibly a single camera facing the driver directly. A camera or cameras can also be located in other locations in the vehicle as long as they provide an unobstructed view of the driver's face. The system may use cameras already installed in the vehicle for other purposes if they provide an unobstructed view of the driver's face and eyes.

One or more distance sensors can also be installed in the vehicle to determine the distance of the light source to the subject's face. For example, the distance sensor may be an ultrasonic sensor that can measure the distance to the subject by emitting a sound wave at a predefined frequency and listening for the return of that sound wave in order to time the trip of the sound wave to the subject and back for determining the distance or an approximation of the distance between the distance sensor and the subject's face.

In order to test for nystagmus, a system may have a mechanism which serves as a stimulus to guide the subject's eyes in a predicted manner. The stimulus can guide the eyes from looking directly forward to what is referred to as extreme gaze which is looking as far as possible to the right or left while keeping the subject's head facing forward.

Lights emitted by the light source 804 can be controlled by the computing device 802 to guide the subject's eyes from a center position to extreme gaze in a precisely timed manner. The emitted lights may be controlled to pause at extreme gaze and also at the initial onset of nystagmus detected as the eyes move from a center position to extreme gaze.

An array of small lights (LED or similar) may also be installed in the vehicle which can be visible to the driver. As with the cameras these lights may be placed at various locations in the vehicle, such as just above the windshield 820 or in one or both of the A-pillars 814. These lights may also be located on the dashboard 818 or any other location that is visible to the driver.

In order for the nystagmus procedure to be valid, the subject must keep their head facing forward and not move it from one side to another as their eyes follow the light stimulus to extreme gaze. The subject's inability to do so may be considered a “clue” of impairment in the standard police procedure.

The image capture devices 806 can capture multiple images or video of the subject's eyes and face. The captured images or video may be digitally saved in memory 824 of the computing device 802. It is noted that the computing device 802 includes one or more processor(s) 826 that can, in combination with memory 824, implement the functionalities of a computing device as described herein. The captured images and/or video may alternatively be stored at a server via Internet connection.

In accordance with embodiments, software may control various features of the system 802. For example, the software may be implemented by the memory 824 and processor(s) 826 of the computing device 802. Alternatively, the features may be implemented by the computing device 802 in combination with other components or hardware of the vehicle, such as the start system of the vehicle. It turns on the system when the vehicle starting mechanism is activated. In example, the computing device 802 may control the display 810 to display text for instructing the driver to look straight ahead and follow the light stimulus. Alternatively, for example, the computing device 802 may communicate these instructions to the subject via the speaker 812. This feature (verbal or text instructions) may be turned off with a control setting in the vehicle.

The image capture device(s) 806 may subsequently start capturing images and/or video while the light stimulus provided by the light source 804 emits light in a predefined pattern for stimulation. Since the pattern is controlled by the system's software it can be configured in a suitable manner for detecting nystagmus or the lack thereof so that the vehicle can be started and the subject can proceed to drive normally. The standard police nystagmus test requires at least four sweeps of the eyes. It is desired to minimize the testing time so that the vehicle may start and the subject may proceed with driving if the impairment testing is successfully passed by the subject. It may also be possible to evaluate smooth pursuit and angle of onset at the same time. The presently disclosed subject matter can provide the ability to modify the current standardized nystagmus test in any way that research shows is effective but reduces the time required by the current procedure.

The system may implement an image stabilization feature to reduce any random movement of the subject's face. The software can also manage the storage function for the images and/or video recorded by the image capture device(s) 806 directing them to one or more storage locations.

In accordance with embodiments, the computing device 802 may receive the captured images for use in analyzing two elements of the subject's movement. The first can be used determine whether the subject's head remains forward facing during the test. This can be accomplished by using suitable facial recognition techniques. This can be an important element of the evaluation because if the subject moves their head in the direction of the stimulus their eyes may not move all the way to extreme gaze. In addition, the subject's inability to maintain their head in a steady position is also considered a clue to impairment in a standard police field test and is factored into the outcome determined by the computing device 802.

Continuing the analysis of analyzing the subject's movement, the second element involves analyzing movement of the subject's eyes. When Nystagmus is present, the eyes display a “jerky” motion at extreme gaze. They can also present a jerky motion as they move toward extreme gaze. This is referred to as the point of onset.

In accordance with embodiments, techniques for impairment analysis disclosed herein can include deep learning techniques. In a movie analogy, the algorithm can segment and track the actor in front of any background. A small overview on how it works: deep learning algorithms are much more sophisticated and are “trained”. These algorithms can learn context about the pictures, e.g. when certain groupings of pixels are together, that usually means they represent a dog, or in a different grouping, a cat. These algorithms that have contextual awareness learned from these millions of data points, and tune them so they work on eye images.

In an example case, a frame (a picture) can be captured by the image capture device(s) 806 at a frame rate determined by the algorithms at variable resolution. The frame can contain the subject face in Red Green Blue (“RGB”) values. Each frame can be processed by the deep learning backend algorithms to find the face. A second deep learning algorithm can be used to identify the same 68 landmarks that every face contains. FIG. 7 illustrates images including an image of a person's and landmarks for creating reference points. As a preprocessing step, key points are passed through Bayesian stabilization filters for robust normalization. These landmarks can be used to create a reference point between all frames captured for stabilizing the face. They are also used to crop out the eyes in order to perform high resolution processing on only the area around the eyes, allowing for real time processing. Each eye is shown to a 3rd deep learning algorithm which classifies every pixel in the image as either belonging to a pupil, iris, or “background” (background here means non pupil/iris). This is called image segmentation made possible by deep learning algorithms. The algorithm is trained on many images as described in the note above and customized for eyes. Subsequently the iris pixels are segmented and the algorithm then uses an ellipse estimation algorithm that tunes the edges of the deep learning algorithm to precisely fit onto the iris. The center of that ellipse is subsequently calculated and stored. The center of the ellipse represents the pupil location and using the reference landmarks, the absolute position of the eye can be determined and tracked over time. The processing chain runs the standard 4 nystagmus tests that are present in the HGN SFST, tracks the absolute 2D coordinates of the pupils, and compares them to what we calculate should be the baseline eye movement of a non-intoxicated individual. The baseline eye movement is calculated using geometry. The movement pattern of the lit up LEDs on the device can be controlled along with the distance from the person's face. Subsequently, the process can work backwards to where their eyes should be looking and the rate of change for their iris positioning.

In a comparison, the positions of the pupil over time can be compared to the ideal positions of pupils over time and an algorithm which calculates the distance between the two points determines the intensity of nystagmus present in the subject under test. This level of nystagmus allows us to gauge the driver's approximate Blood Alcohol Content (“BAC”) because the larger “distances” in this comparison indicate a more drastic intoxication level. An additional feature is determining the precise BAC based on the angle of onset of nystagmus. This can be implemented by pausing the light source at the exact angle of onset which is determined by the backend processing algorithms which can control the light source or by recording the light position at the angle of onset. The algorithm may assess all the data within the 4 tests and returns a “clue” for each test, indicating whether or not nystagmus is present, and finally it returns an estimation of the subjects Blood Alcohol concentration. The video of the process can be saved and labeled.

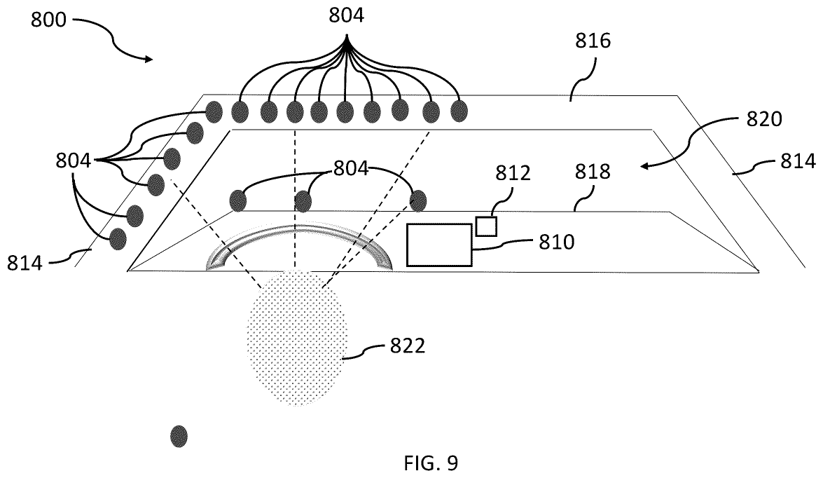

FIG. 9 illustrates a diagram of the vehicular impairment detection system 800 with indications of alternative positions of light sources 804. These positions indicate where one or more of the light sources 804 may be positioned for emitting light to illuminate the subject's face 822. It is noted that in this figure some of the components of the system 800 are omitted for clarity of its depiction.

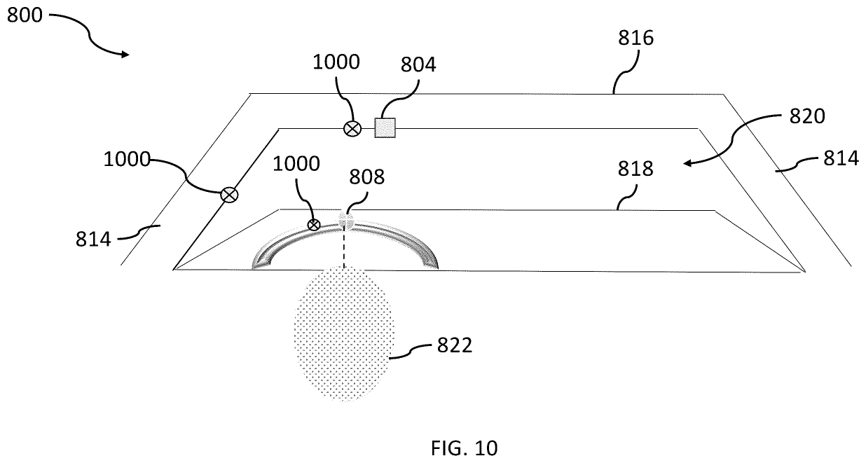

FIG. 10 illustrates a diagram of the vehicular impairment detection system 800 with a distance sensor 808, one or more ambient light sensors 1000, and a light source 804 in accordance with embodiments of the present subject matter. The ambient light sensors 808 may be configured to detect ambient light to facilitate detection of features of the subject's face and eyes in accordance with embodiments of the present disclosure. It is noted that in this figure some of the components of the system 800 are omitted for clarity of its depiction.

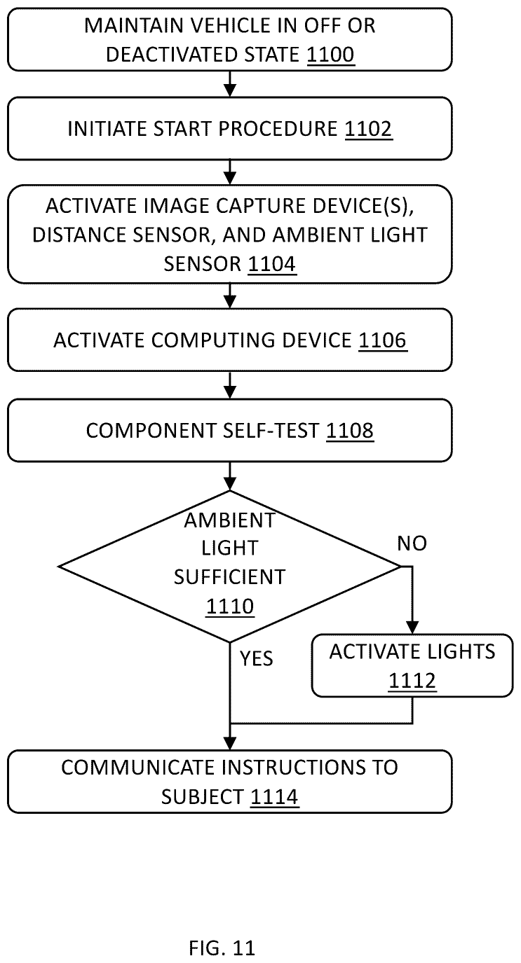

FIG. 11 illustrates a flow diagram of an example method for vehicular starting and testing in accordance with embodiments of the present disclosure. The method of FIG. 11 may be implemented by any suitable system described herein, such as the vehicular impairment detection systems shown in FIGS. 8-10. Referring to FIG. 11, the method includes maintaining 1100 a vehicle in an off state or a deactivated state until a test cycle is completed and it is determined that a subject under test is not impaired or not at an unsafe level of impairment. The vehicle is maintained in the off state or deactivated state if it is determined that the subject under test is at an unsafe level of impairment.

At block 1102, a starting procedure may be initiated by the subject. For example, the subject may sit in the driver seat of the vehicle and subsequently select an input for starting the vehicle or specifically for initiating the test for impairment. For example, the subject may push a start button for the vehicle, or interact with a display or other interface for initiating the test for impairment.

With continuing reference to FIG. 11, the system's image capture device(s), distance sensor, and ambient light sensor are activated 1104 in response to initiation of the starting procedure. For example, the image capture device(s) 806, distance sensor 808, and ambient light sensor(s) 1000 shown in FIG. 10 can be activated in response to initiation of the starting procedure. In addition, the method may include activating 1106 the computing device (e.g., computing device 802) for implementing the test. At block 1108, the system's components can implement a self-test.

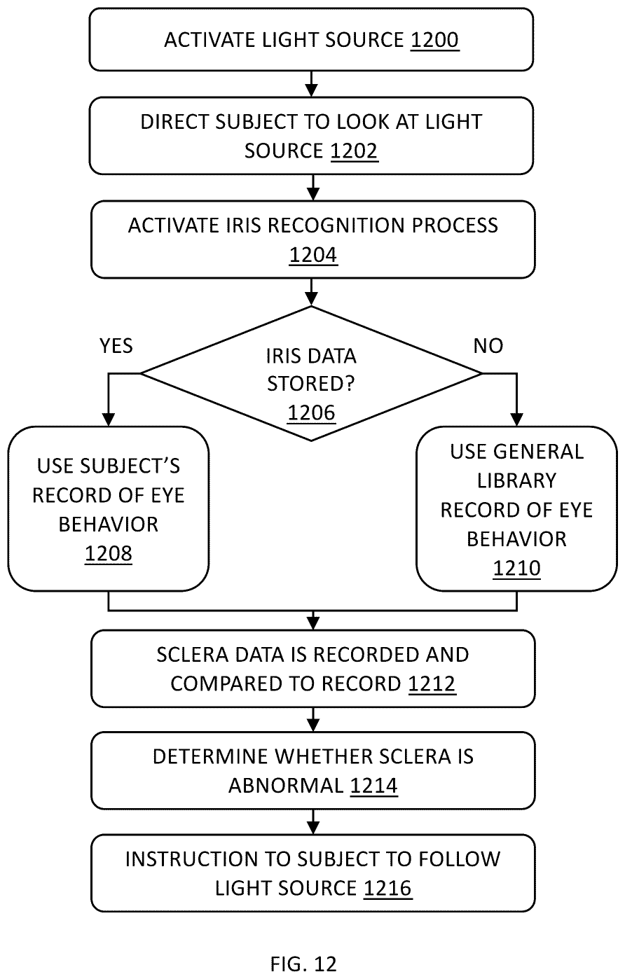

In addition, the method can include determining 1110 whether the ambient light is sufficient (e.g., by use of ambient light sensor(s) 1000). In response to determining that the ambient light is insufficient, the method may proceed to block 1112 where vehicle cabin lights or a system ambient light source are activated. Subsequently and in response to determining that ambient light is sufficient, the method can proceed to block 1114 where instructions are communicated to the subject. For example, the instructions may be automated voice instructions, including instructing the subject to look ahead and keep head steady for impairment testing. At this stage after block 114, the system may proceed to additional start and test procedures, such as described in the example of FIG. 12.

FIG. 12 illustrates a flow diagram of an example method that follows the method of FIG. 11 in accordance with embodiments of the present disclosure. Referring to FIG. 12, the method includes activating 1200 a light source. For example, a center light source may be activated. The method also includes directing 1202 the subject to look at the light source. For example, the iris recognition process can be activated 1204, and the computing device can instruct the image capture device to capture images of the eye to thereby capture iris data. The captured image data can be sent to memory. Further, the computing device can check its database to determine 1206 if the iris data is recognized and a record of the subject's normal eye behavior can be stored. If iris data is stored in memory, the method may proceed to block 1208. If iris data is not stored in memory, the method may proceed to block 1210.

With continuing reference to FIG. 12, at block 1208 the computing device can select the subject's record of normal eye behavior for comparison. At block 1210, the computing device can select from a general library for normal or abnormal eye behavior for comparison.

Subsequent to blocks 1208 and 1210, sclera data is recorded and compared 1212 to record. For example, the computing device can determine whether the subject's sclera displays abnormal dilation of the conjunctival vessels overlying the sclera and stores the conclusion in memory. Further, at block 1214, the method includes instructing the subject to follow light source. For example, the computing device can control a user interface of the vehicle to instruct the subject to follow the light source with eyes while holding the head steady in a forward-facing position.

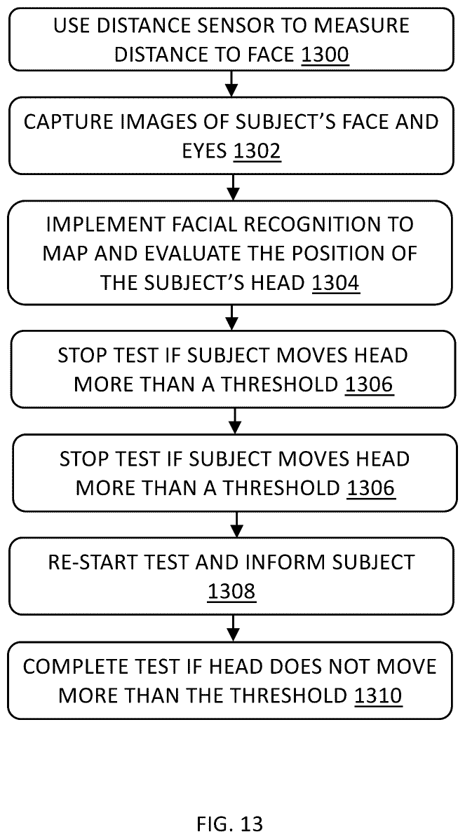

FIG. 13 illustrates a flow diagram of an example method for vehicle start and testing procedures as a continuation of the method of FIG. 12 in accordance with embodiments of the present disclosure. Referring to FIG. 13, the method includes activating 1300 a distance sensor to measure distance to the subject's face. For example, the distance sensor 808 of FIG. 10 can be activated and continuously measure distance to the subject's face. Further, the method includes capturing 1302 images of the subject's face and eyes. For example, one or more image capturing devices as described herein may be utilized to capture images or video of the subject's face and eyes. Further, the captured images or video can be moved the computing device's memory.

The method of FIG. 13 includes implementing 1304 facial recognition software to map and evaluate the position of the subject's head. For example, FIG. 7 and its description provides an example of using images of a subject for generating landmarks using reference points.

The method of FIG. 13 includes stopping 1306 test if subject moves head more than a threshold amount. For example, the computing device can stop the test if the subject is determined to move her or his head beyond a predetermined amount. The computing device can stop the test and prevent start of the vehicle if this is determined. Subsequently, the light source can be returned to the center or otherwise reset. The computing device can also control a user interface to inform the subject that his or her head has been moved too much.

The method of FIG. 13 includes re-starting 1308 the test and informing the subject. For example, the computing device may re-start the test and control a user interface to inform the subject that the test has been re-start, to look forward, and follow light source with eyes. For example, the sequence may be re-started. Further, the method of FIG. 13 includes completing 1310 the test if the subject's head does not move more than the threshold.

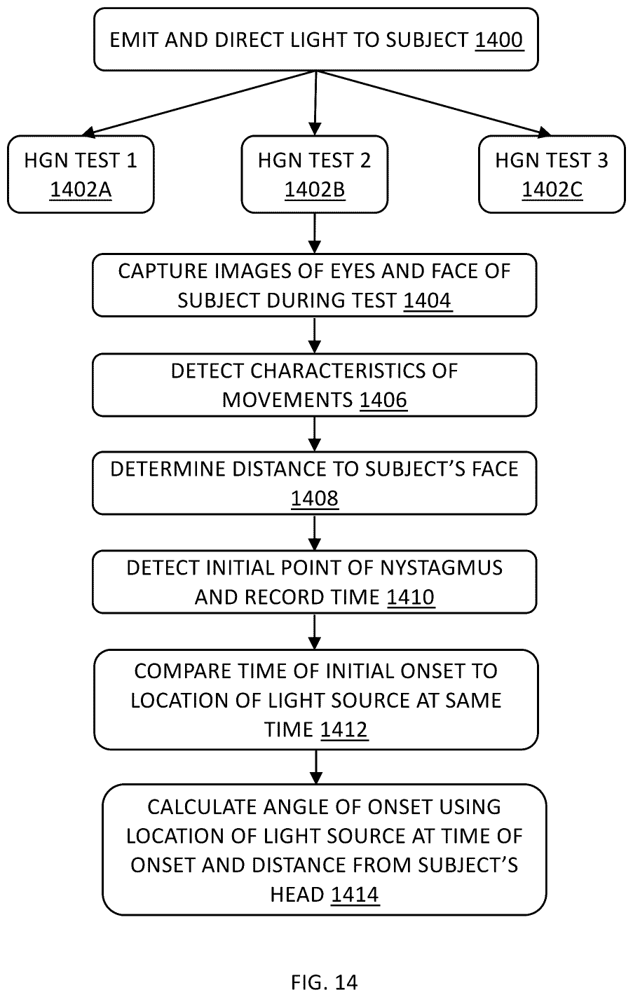

FIG. 14 illustrates a flow diagram of an example method for vehicle start and testing procedures as a continuation of the method of FIG. 13 in accordance with embodiments of the present disclosure. Referring to FIG. 14, the computing device can control the light source to emit and direct light towards the subject's face in a predetermined pattern. The sequence can be programmed in any suitable sequence. For example, the sequence can be programmed to perform the complete SFST HGN test or a portion thereof.

The method of FIG. 14 includes implementing either one of multiple different HGN tests. For example, the computing device may implement HGN Test 1 1402A, HGN Test 2 1402B, or HGN Test 3 1402C. HGN Test 1 is a smooth pursuit test, where the subject's eyes are directed from center gaze to an extreme gaze on the left. Subsequently, the subject's eyes may be directed by the light source to return to the center, and then to the extreme gaze on the right. The test may then sequence the same eye movements again.

HGN Test 2 is an extreme gaze test. This test includes directing the eyes from center to an extreme gaze on the left and paused for 4 seconds. Subsequently, the eyes are directed back to center and then to an extreme gaze on the right, where they are paused for 4 seconds. The test may then sequence the same eye movements again.

HGN Test 3 is an angle of onset test. This test includes directing the eyes from center to an extreme gaze on the left. The system may observe a precise location when nystagmus is first observed prior to the extreme gaze. Subsequently, the eyes are directed back to center and then to an extreme gaze on the right. The test may then sequence the same eye movements again.

With continuing reference to FIG. 14, the computing device uses the image capture device to capture 1404 images of the eyes and face of the subject during the test (e.g., HGN Test 1, 2, or 3). The computing device is configured to capture precise light positions at precise times throughout the entire sequence. Further, the computing device can use the captured images to detect 1406 characteristics of the movements of the eyes and/or face. For example, the computing device may detect facial movement, smooth pursuit, nystagmus at extreme gaze, and/or angle of onset of nystagmus. It is noted that FIG. 4 and its description provides an example of impairment analysis. Also, example clues of impairment exceeding a threshold level include, but are not limited to, determining whether the subject has atypical dilation of the conjunctival vessels (i.e., “blood shot eyes”), determining whether the subject's eyes follow the light source smoothly (i.e., smooth pursuit), determining whether the subject's eyes display nystagmus at extreme gaze, and determining angle of onset of nystagmus.

With continuing reference to FIG. 14, a distance sensor is utilized 1408 to determine a distance from the subject's face continuously or periodically at a precise time of every observation. Further, an initial point where nystagmus is detected (“onset”) as eyes move toward extreme gaze, and the precise time of the detection of onset of nystagmus is recorded (block 1410). Block 1412 includes comparing a time of initial onset of nystagmus to a location of the light source at the same time. Further, block 1414 includes calculating angle of onset of nystagmus using a location of the light source at the time of onset and the distance from the subject's head.

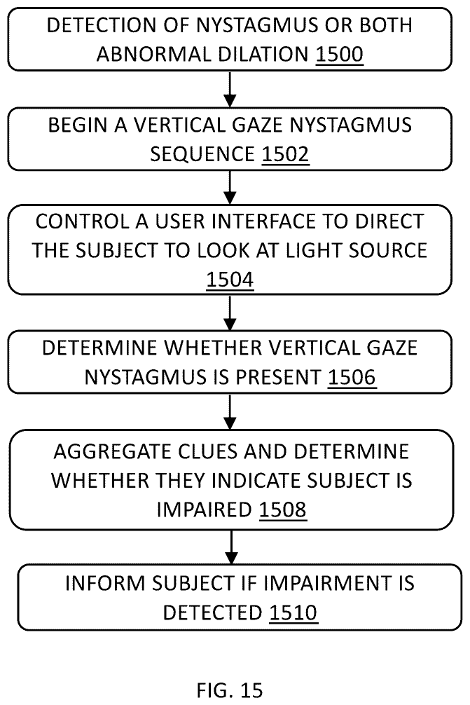

FIG. 15 illustrates a flow diagram of an example method for vehicle start and testing procedures as a continuation of the method of FIG. 14 in accordance with embodiments of the present disclosure. Referring to FIG. 15, the computing device can detect 1500 nystagmus or both nystagmus and abnormal dilation of the conjunctival vessels overlying the sclera. At block 1502, the system can begin a vertical gaze nystagmus sequence. In this sequence, the computing device can control 1504 a user interface to direct the subject to look at the light source directly in front of and above the face. Further, the method includes determining 1506 whether vertical gaze nystagmus is present or not. The computing device can aggregate 1508 clues detected and determine whether they indicate driver impairment.

With continuing reference to FIG. 15, the computing device can control the user interface to inform the subject if impairment is detected. For example, if there is a conclusion that the subject is displaying indications of impairment, then a voice prompt can inform the subject. The subject may be given the option of restarting the procedure. If the system is using a shortened version of the SFST full HGN test, then the subject may be given the option to take the full test. If the subject selects to take the test again, the subject can use voice or text commands to inform the system, and the test can begin from the start. Further, if the subject selects not to take the test again, then the vehicle is disabled from starting until the next initiation of the starting procedure. In contrast, if the indication is no impairment, then the vehicle may be enabled to start.

In accordance with embodiments, a method may be implemented by the impairment analyzer disclosed herein. The method includes a face detection step. Subsequently, the method includes face/pose localization. Further, the method includes iris segmentation for eye tracking. The method also includes determining relative eye tracking data. For a small intoxication dataset, the method includes Fast Fourier Transformation (FFT) of the data. The method also includes determining gradient boosted trees classification/regression. Further, for a large intoxication dataset, the method includes determining 1-Dimension (1D) CC for waveform analysis. These steps may be used for HGN detection.

In an alternative method, the steps of iris segmentation may be replaced with a step of deep learning based on iris segmentation. Iris segmentation may be implemented by computer vision made possible by a deep learning technique. This processing method is extremely robust to various lighting conditions and may not use any iris segmentation techniques. This chain may need a facial reference point and can still produce relative eye tracking data. The iris segmentation may be offloaded to a separate processor that is optimized to run edge inference of deep learning models.

In accordance with embodiments, an example method for impairment analysis in accordance with embodiments of the present disclosure. The method may be implemented by the impairment analyzer disclosed herein. In an example of HGN detection for impairment analysis, a video of the person is captured using the camera on the device. The video is captured using an infrared camera with infrared lighting illuminating the face at 60 Hz and each frame is sequentially analyzed. This video feed is the beginning of the processing pipeline. The next three steps are applied to each frame with the final steps occurring using the aggregated data extracted from the frames. The processor may be the part of the vehicle's computer system but may also be separate and which has the range of functionality to include deep learning support. An open source facial detection algorithm may be used to detect the face in the picture. This can be from any number of libraries but OpenCV or dlib may be used. Once a face is detected, facial landmarks (e.g., corner of mouth, noise tip, jaw line, etc.) are computed, which correspond to 68 points of different positions on the subject's face. From here, a facial pose/position is calculated and used as a reference point. This can be an average of all the points on a 2D plane or a mapped 3D facemask using 3DDFA/PRNet (The second is significantly more resource intensive, but gives higher accuracy). This reference point is necessary because there is a gaussian noise introduced by the movement of the camera/subject from frame to frame. The pupil and iris are segmented. Each eye is cropped using common ratio from a human face and the segmentation masks are created. From these segmentation masks the pupil centers are calculated and stored normalized to the reference point. The segmentation can be performed a number of ways. This may be done with a conversion to a binary image and creating a pixel intensity thresholding mask. From there a Hugh circle fitting algorithm is used to fit circles because the iris with pupil do not change in shape. A deep learning iris segmentation technique trained on iris and pupil data can be used which create a mask on the iris and allow us to segment all iris and pupil pixels. These techniques are state of the art, novel, and resource intensive. The eye movement data may be aggregated and built into a time series. To classify clues, a Hanning window may be applied over the time series data converted into the frequency domain using a discrete Fourier transform. This windowing function pulls out periodic eye movement data frequencies and allows the system to classify the stability/smoothness of eye movement, which is the mathematical interpretation of “stuttering” eye movement seen in intoxicated subjects during the horizontal gaze nystagmus test. The 1D CNN for classification is currently not explored but is another potential solution.

The device may include the components of the vehicular impairment detection systems described herein. The device may have multiple CPUs and a GPU which runs an operating system that records video, manages stimulus, and runs/evaluates signal processing algorithms. The device may be operable to communicatively connect to a WI-FI® network, Bluetooth, or any other communications network. The device may have multiple CPUs and a GPU which runs an operating system that records video, manages stimulus, and runs/evaluates signal processing algorithms. The device may be operable to communicatively connect to a WI-FI® network or any other communications network.

The system may also use facial recognition or standard iris detection software to identify the driver. The system memory can hold images of the driver's non impaired eyes both facing forward and moving to extreme gaze on both the left and right sides. This data can be easily recorded and stored the first time the driver uses the car and then remains permanently in the system. Data for multiple drivers can be recorded and stored. Drivers of the vehicle can elect not to have their data stored. In this case, the system can compare the driver's eyes to a machine learning library of normal and abnormal eye movement stored in its database.

Once the test is completed the software would send a signal to the starting mechanism of the vehicle to allow it to proceed unless the driver failed the nystagmus test in which case the starting mechanism would be locked and the driver would be informed that they had failed the test verbally or through a message on a screen or both. The driver—or another driver—would have the option to repeat the test as often as they wish however as long as the system detects sufficient clues of impairment it will not allow the vehicle to start. The device could also be configured so that if the driver fails the first short test they could request a longer test which would incorporate more sweeps of the eyes.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A vehicular impairment detection system for a vehicle, the vehicular impairment detection system comprising:
an interface configured to communicate a start control signal to a start system of a vehicle;
a light source configured for attachment to an interior component of the vehicle;
an image capture device that captures a plurality of images of an eye of a subject illuminated by light over a period of time, wherein the image capture device is configured for attachment to an interior component of the vehicle;
a computing device comprising at least one processor and memory configured to:
control the light source to emit light in a predetermined pattern for guiding the subject's eyes during capture of the plurality of images of the eye over the period of time;
receive, from the image capture device, the captured plurality of images, wherein the images include pixels corresponding to a pupil, iris, background, or other features of the eye of the subject;
maintain a database of machine learning analysis of other subject's normal and abnormal eye behavior in response to an applied light stimulus;
classify pixels from the captured plurality of images as either pupil, iris, background, or other features of the eye of the subject based on the machine learning library;
track movement of the classified pixels in the plurality of images over the period of time;
analyze impairment of the subject based on the tracked movement as compared to the machine learning analysis in the database;
determine that the subject is at an unsafe level of impairment based on the analysis of impairment; and
communicate, to the interface, a control signal to disable the start system of the vehicle based on a determination that the subject is at an unsafe level of impairment.

2. The vehicular impairment detection system of claim 1, wherein the computing device is configured to determine a quantity of red in the sclera of the eye of the subject in the plurality of images, and wherein the analysis of impairment is based on a comparison of the determined quantity of red to a normal quantity of red for the subject or to a database of other subjects' normal quantity of red and possibly a database of eyes which indicate a similar condition to the subject.

3. The vehicular impairment detection system of claim 1, wherein the image capture device is configured to capture a plurality of images of the subject's face over the period of time, and
wherein the computing device is configured to determine movement of the subject's head over the period of time; and
wherein the analysis of impairment compensates for the movement of the subject's head to the relative tracked movement of the classified pixels.

4. The vehicular impairment detection system of claim 1, wherein the computing device is configured to communicate a command signal to a user interface for instructing the subject to interact with the vehicular impairment detection system.

5. The vehicular impairment detection system of claim 4, wherein the instruction to the subject includes one of voice instructions and display instructions.

6. The vehicular impairment detection system of claim 4, wherein the instruction includes directing the subject to look at the light source or other locations such as straight forward.

7. The vehicular impairment detection system of claim 4, wherein the instruction includes:
directing the subject to look at the light source that directs the driver's eyes;
informing the subject in an instance that the subject has moved her or his head while following the light source; and/or
informing the subject to follow the light source that guides the subject's eyes to extreme gaze.

8. The vehicular impairment detection system of claim 1, wherein the computing device is configured to determine lack of smooth pursuit based on tracked movement of the classified pixels, and
wherein the analysis of impairment is based on the determined lack of smooth pursuit.

9. The vehicular impairment detection system of claim 1, wherein the computing device is configured to detect angle of onset of nystagmus based on tracked movement of the classified pixels, and
wherein the analysis of impairment is based on the detected angle of onset of nystagmus.

10. The vehicular impairment detection system of claim 1, wherein the computing device is configured to detect extreme gaze nystagmus based on tracked movement of the classified pixels, and
wherein the analysis of impairment is based on the detected extreme gaze nystagmus.

11. The vehicular impairment detection system of claim 1, wherein the computing device is configured to detect smooth pursuit, or angle of onset and extreme gaze nystagmus present in the driver's eyes to either the right or left based on tracked movement of the classified pixels, and
wherein the analysis of impairment is based on the detection.

12. The vehicular impairment detection system of claim 1, wherein the computing device is configured to detect nystagmus using the HGN test based on the tracked movement of the classified pixels, and
wherein the analysis of impairment is based on the detection.

13. The vehicular impairment detection system of claim 1, wherein the computing device is configured to detect vertical gaze nystagmus based on the tracked movement of the classified pixels, and
wherein the analysis of impairment is based on the detection.

14. The vehicular impairment detection system of claim 1, wherein the computing device is configured to detect horizontal gaze nystagmus based on the tracked movement of the classified pixels, and
wherein the analysis of impairment is based on the detection.

15. The vehicular impairment detection system of claim 1, wherein the computing device is configured to identify the subject based on the captured images of the face or iris.

16. The vehicular impairment detection system of claim 15, wherein the computing device is configured to:
store the subject's normal eye movement in response to an applied light stimulus; and
use the stored subject's normal eye movement for the analysis of impairment of the subject.

17. The vehicular impairment detection system of claim 15, wherein the computing device is configured to:
determine that there is no stored eye movement data for the subject; and
use the database of machine learning analysis for analyzing the impairment of the subject in response to determining that there is no stored eye movement data for the subject.

18. The vehicular impairment detection system of claim 1, wherein the computing device is configured to communicate a command signal to a user interface for informing the subject that the start system of the vehicle is disabled based on the determination that the subject is at an unsafe level of impairment.

19. The vehicular impairment detection system of claim 1, wherein the computing device is configured to:
interact with the subject for permitting additional testing for determining whether the subject is at the unsafe level of impairment;
receive, from the image capture device, other captured plurality of images of the eye of the subject;
analyze impairment of the subject based on tracked movement of the eye within the other capture plurality of images;
determine that the subject is not at an unsafe level of impairment based on the analysis of impairment; and
communicate, to the interface, a control signal to enable the start system of the vehicle based on a determination that the subject is not at the unsafe level of impairment.

20. The vehicular impairment detection system of claim 1, wherein the movement of the light source and the tracked movement is in a predetermined sequence of directions.
